(19) United States
(12) Patent Application Publication
(10) Pub. No.: US 2022/0176283 A1
(43) Pub. Date: Jun. 9, 2022

(54) COMPOSITE STRUCTURE, METHOD OF MANUFACTURING THE SAME, AND FILTER MEDIUM CONTAINING THE COMPOSITE STRUCTURE

(71) Applicants: JNC CORPORATION, Tokyo (JP); JNC FIBERS CORPORATION, Tokyo (JP)

(72) Inventors: You UMEBAYASHI, Shiga (JP); Shimpei HIRAMOTO, Shiga (JP); Hidemi ITO, Shiga (JP)

(73) Assignees: JNC CORPORATION, Tokyo (JP); JNC FIBERS CORPORATION, Tokyo (JP)

(21) Appl. No.: 17/598,291

(22) PCT Filed: Mar. 11, 2020
(86) PCT No.: PCT/JP2020/010626

§ 371 Date: Sep. 26, 2021

(30) Foreign Application Priority Data
Mar. 28, 2019 (JP) 2019-064343

(51) Int. Cl. B01D 39/16; D01D 5/00; D04H 1/728; D04H 1/413; D04H 1/4382; D04H 1/4318; D01F 6/12

(52) U.S. Cl. CPC B01D 39/1623; D01D 5/0046; D04H 1/728; D04H 1/413; D04H 1/43838; D10B 2505/04; D01F 6/12; B01D 2239/0631; B01D 2239/10; B01D 2239/1233; B01D 2239/1241; D04H 1/4318

(57) ABSTRACT

Provided are: a filter medium with high dust collection efficiency, low pressure loss, and a long lifespan; and a filter material used for the filter medium. This composite structure includes ultrafine fibers having a fiber diameter of less than 500 nm, and beads. The outermost surface of the composite structure has at least 500/mm² of beads with a diameter of 5 μm or more. The ultrafine fibers and the beads preferably have the same component.

### TECHNICAL FIELD

The present invention relates to a composite structure, a method of manufacturing the same, and a filter medium containing the same.

### BACKGROUND ART

Conventionally, a non-woven fabric sheet is often used as a filter medium for an air filter which removes fine dust such as pollen and fine particles. Such a filter medium for a filter is required to have performance to collect dust with high efficiency (high collection efficiency) and performance with low resistance when a fluid passes through the filter medium (low pressure loss).

As a method of achieving the high collection efficiency and the low pressure loss, a filter medium using ultrafine fibers has been proposed. For example, Patent Literature 1 proposes a filter medium with an ultrafine fiber layer having an average fiber diameter of 170 nm or less. However, in such a filter medium, pressure loss of the obtained filter tends to increase because the ultrafine fibers form a dense matrix.

As a method for solving the problems of low pressure loss and a long lifespan in a filter medium using ultrafine fibers, a mixed fiber filter medium in which ultrafine fibers and fibers thicker than ultrafine fibers are mixed has been proposed. For example, Patent Literature 2 proposes a non-woven fabric in which ultrafine fibers formed by electrostatic spinning and melt blow fibers formed by a melt blow method are mixed. However, since the filter medium of Patent Literature 2 combines fiber manufacturing methods using different principles, a manufacturing apparatus becomes complicated and it is not always preferable in terms of manufacturing efficiency.

Further, for example, Patent Literature 3 proposes a filter medium formed of nano-fibers formed of beaded fibers in which nano-fibers and beads are integrated. The filter medium of Patent Literature 3 is for an air filter, and an average fiber diameter of the beaded fibers is 0.001 to 0.13 μm. Further, it is described that a bead diameter of the beaded fibers is 2 to 10 times the average fiber diameter thereof, and the bead diameter of the beaded fibers described in the examples is about several hundred nm. In Patent Literature 3, according to the filter medium for an air filter formed of such beaded fibers, it is disclosed that the fiber diameter can be maintained to be thin, and at the same time, a required interfiber distance can be secured, and an air filter formed of a filter medium using such beaded fibers can be improved in performance. However, the filter medium for an air filter of Patent Literature 3 also has room for further improvement in the low pressure loss and the lifespan of the air filter.

### REFERENCE LIST

### Patent Literature

Patent Literature 1: Japanese Patent Laid-Open No. 2006-341233
Patent Literature 2: Japanese Patent Laid-Open No. 2009-057655
Patent Literature 3: Japanese Patent Laid-Open No. 2010-247035

### SUMMARY OF INVENTION

### Technical Problem

An objective of the present invention is to solve the above-described problems, to provide a filter medium having high dust collection efficiency, low pressure loss, and a long lifespan, and to provide a filter material used for the filter medium.

### Solution to Problem

The present inventors have conducted extensive research to solve the above-described problems, and have focused on a size of beads in a filter material having a composite structure containing ultrafine fibers and beads, and have found that when the beads are too small, a sufficient effect for improving the performance of the air filter cannot be obtained. Additionally, they confirmed that the size of the beads and the content of the beads have a great influence on the performance of the filter. As a result of further examination, they found that a composite structure containing beads of a specific range of size in a specific range of density in a matrix of ultrafine fibers can provide a filter medium with high dust collection efficiency, low pressure loss, and a long lifespan, and furthermore confirmed that such a composite structure can be manufactured in a reasonable process and at a reasonable cost by adjusting materials and conditions of electrostatic spinning, and thus completed the present invention.

The present invention has the following configuration.

[1] There is provided a composite structure containing ultrafine fibers having a fiber diameter of less than 500 nm and beads, wherein the beads of at least 500/mm² having a diameter of 5 μm or more are contained on an outermost surface of the composite structure.

[2] In the composite structure described in [1], the ultrafine fibers and the beads may have the same component.

[3] In the composite structure described in [1] or [2], 50% or more of ultrafine fibers having a fiber diameter of 200 nm or less may be contained with respect to the total fibers.

[4] In the composite structure described in any one of [1] to [3], 5% or more of ultrafine fibers having a fiber diameter of 500 nm or less may be further contained with respect to the total fibers.

[5] There is provided a filter medium including the composite structure according to any one of [1] to [4].

[6] There is provided a method of manufacturing the composite structure according to any one of [1] to [4], including preparing a spinning solution in which at least one resin selected from a group consisting of polyvinylidene fluoride, polyimide, polyurethane, and polylactic acid is dissolved in a solvent, and spinning the spinning solution in an electrostatic spinning method and obtaining a composite structure containing ultrafine fibers having a fiber diameter of less than 500 nm and beads.

### Advantageous Effects of Invention

It is possible to manufacture and provide a filter medium having high dust collection efficiency, low pressure loss, and a long lifespan at a reasonable cost using the composite structure of the present invention.

### BRIEF DESCRIPTION OF THE DRAWINGS

FIG. 1 is a scanning electron microscope image of a composite structure (Example 1) of the present invention.

FIG. 2 is a scanning electron microscope image of a composite structure (Example 2) of the present invention.

FIG. 3 is a scanning electron microscope image of a composite structure (Example 3) of the present invention.

FIG. 4 is a scanning electron microscope image of a composite structure (Example 4) of the present invention.

FIG. 5 is a scanning electron microscope image of a composite structure (Example 5) of the present invention.

FIG. 6 is a scanning electron microscope image of a fiber layer (Comparative Example 1) outside the scope of the present invention.

FIG. 7 is a scanning electron microscope image of a fiber layer (Comparative Example 2) outside the scope of the present invention.

### DESCRIPTION OF THE EMBODIMENTS

Hereinafter, the present invention will be described in detail.

A composite structure of the present invention is characterized by containing ultrafine fibers having a fiber diameter of less than 500 nm and beads, and the outermost surface of the composite structure having beads of at least 500/mm² with a diameter of 5 or more. In the composite structure of the present invention, since a distance between the ultrafine fibers can be appropriately maintained by the large number of beads having the relatively large size of 5 μm or more in diameter being present in a matrix of the ultrafine fibers, it is considered possible to provide a filter medium having high dust collection efficiency, low pressure loss, and a long lifespan. From this point of view, the number of beads having a diameter of 5 μm or more is more preferably at least 1000/mm², and even more preferably at least 1500/mm². The composite structure of the present invention is generally a thin film-shaped object having an opaque and smooth surface to the naked eye, and when the composite structure of the present invention is magnified with an electron microscope or the like, it can be observed that a large number of beads are present and dispersed in the matrix of the ultrafine fibers. In the present specification, an ultrafine fiber is a fiber having a fiber diameter of less than 500 nm, and hereafter, unless otherwise specified, “ultrafine fiber” means a fiber having a fiber diameter of less than 500 nm.

Although the ultrafine fibers contained in the composite structure of the present invention are not particularly limited as long as the effects of the present invention are obtained, fibers having a fiber diameter of 200 nm or less are preferably contained in an amount of 50% or more, more preferably 70% or more, and even more preferably 80% or more with respect to the total fibers. When a proportion of fibers having a fiber diameter of 200 nm or less is 50% or more, a specific surface area of the ultrafine fibers becomes large, and when the composite structure is used as a filter medium, it is possible to obtain high filter performance such as low pressure loss and high collection efficiency.

A ratio of fibers here is a ratio (%) of the number of fibers having a predetermined fiber diameter to the total number (the number) of all fibers.

Although an average fiber diameter for all the fibers contained in the composite structure of the present invention is not particularly limited as long as the effects of the present invention are obtained, it is preferably in a range of 10 to 500 nm, more preferably in a range of 20 to 300 nm, and even more preferably in a range of 30 to 100 nm. When the average fiber diameter is 500 nm or less, the specific surface area becomes large, and when the composite structure is used as a filter medium, it is possible to obtain high filter performance such as low pressure loss and high collection efficiency. On the other hand, as the fiber diameter decreases, the strength per fiber decreases, and it may cause fiber breakage during processing or use of the filter, but when the average fiber diameter is 10 nm or more, sufficient single yarn strength can be obtained. A coefficient of variation of the fiber diameter with respect to all the fibers contained in the composite structure is not particularly limited, and may be less than 0.5, or 0.5 or more. When the coefficient of variation of the fiber diameter is less than 0.5, the proportion of fibers which effectively act on the collection of dust increases, and high collection efficiency can be obtained with a small amount of fibers. When the coefficient of variation of the fiber diameter is 0.5 or more, a distance between the fibers is widened, and a lifespan of the filter can be improved. In the composite structure of the present invention, fibers having a small coefficient of variation in fiber diameter (for example, less than 0.5, preferably less than 0.3) may be used according to intended use, performance, and the like, and it is also preferable to include fibers having different fiber diameters.

The composite structure of the present invention is characterized in that the outermost surface thereof contains beads of at least 500/mm² having a diameter of 5 μm or more, and the average diameter of the beads contained in the composite structure is not particularly limited, but is preferably in a range of 3 to 30 μm, and more preferably in a range of 5 to 20 μm. In a case that the average diameter is 3 μm or more, when the composite structure is used as a filter medium, it is preferable because high filter performance such as low pressure loss and a long lifespan can be obtained, and when the average diameter is 30 μm or less, the distance between the ultrafine fibers does not increase too much, and thus it is preferable because the composite structure can maintain high strength and is less likely to break during processing into a filter. The diameter of the beads can be measured and calculated by measuring the diameter of the beads present on the outermost surface of the composite structure with image analysis software using a scanning electron microscope. A more specific method of measuring the diameter of the beads will be described in the embodiment section.

The beads contained in the composite structure of the present invention are lumps having a spherical or spindle shape, or a similar shape, and can be observed with an electron microscope, for example. The beads may be formed of a single bead itself, or may be a substantially spherical lump having an uneven surface in which a large number of finer particles are aggregated and integrated. In order to obtain beads having a relatively large size, preferably, the beads have a shape in which a large number of fine particles are aggregated and integrated. When the beads have a spindle shape, a length of a minor axis of the spindle is the diameter of the beads. The content of the beads is calculated by the number of beads per unit area present on the outermost surface of the composite structure. The composite structure of the present invention has a structure in which a large number of beads are present and dispersed in a three-dimensional matrix of fibers formed by ultrafine fibers, and when the content of the beads is calculated, only the number of beads present on the outermost surface is counted, and the number of beads contained per area is calculated.

In the composite structure of the present invention, the ultrafine fibers and the beads are present independently of each other, and a form in which they are held by the beads entering void parts of a matrix formed of the ultrafine fibers, a form in which the beads are formed by bulging some of the ultrafine fibers, that is, the fibers and the beads are integrally connected (in a rotary shape), or a mixture of both forms may be adopted. Typically, they are in a state in which a form in which the beads are mixed in a matrix of the ultrafine fibers and a form in which they are connected in a rosary shape are mixed.

The ultrafine fibers and beads may have the same component or may have different components, but from the viewpoint of uniformity of the composite structure, stability during production, and the like, it is preferable that the composite structure have the same component, and specifically, a resin having the same component is preferably used. Such a resin is not particularly limited, and examples thereof include polymer materials such as polyvinyl alcohol, polyethylene glycol, polyethylene oxide, polyvinylpyrrolidone, polyethylene, polypropylene, polyethylene terephthalate, polylactic acid, polyamide, polyurethane, polystyrene, polysulfone, polyethersulfone, polyvinylidene fluoride, polyacrylonitrile, polymethylmethacrylate, polyglycolic acid, polycaprolactone, polyvinyl acetate, polycarbonate, polyimide, polyetherimide, cellulose, a cellulose derivative, chitin, chitosan, collagen, gelatin, and copolymers thereof. From the viewpoint of ease of forming the beads, polyvinylidene fluoride, polyamide, polyurethane, and polylactic acid are preferable, and polyvinylidene fluoride is more preferable. A weight average molecular weight of the resin is not particularly limited, but is preferably in a range of 10,000 to 10,000,000, more preferably in a range of 50,000 to 1,000,000, and even more preferably 300,000 to 600,000. When the weight average molecular weight is 10,000 or more, it is preferable because formability of the ultrafine fibers and the beads is excellent, and when it is 10,000,000 or less, it is preferable because it is excellent in solubility and thermoplasticity and easy to process.

In addition to the above-described ultrafine fibers and beads, the composite structure of the present invention may further contain fine fibers having an average fiber diameter larger than the average fiber diameter of the ultrafine fibers. When the fine fibers are contained, the fine fibers may be stacked or mixed in the composite structure containing the ultrafine fibers and the beads. The strength of the composite structure is increased by including the fine fibers, which prevents it from breaking easily during processing into a filter. From this point of view, preferably, the fine fibers are mixed in the composite structure so that the strength of the composite structure is improved. The average fiber diameter of the fine fibers is not particularly limited, but is preferably in a range of 500 to 5000 nm, and more preferably in a range of 600 to 2000 nm. When the average fiber diameter of the fine fibers is 500 nm or more, the strength of a composite structure cloth is increased, the processability is improved, the distance between the ultrafine fibers is increased, and when it is used as a filter medium for a filter, it is less likely to be clogged by the collected dust, and the lifespan of the filter can be extended. When the average fiber diameter of the fine fibers is 5000 nm or less, an effect suitable for use can be obtained even with a relatively low basis weight, the filter can be made thinner, and productivity can be improved. The fine fibers having a fiber diameter of 500 nm or more are preferably contained in an amount of 5% or more, more preferably 10% or more with respect to the total fibers. The coefficient of variation of the fiber diameter of the fine fibers is not particularly limited, but is preferably 0.5 or less, and more preferably 0.3 or less. When the coefficient of variation of the fine fibers is 0.5 or less, the effect suitable for use such as improving the strength of a complex can be obtained even with a low basis weight, and thus the filter can be made thinner and smaller.

The resin of the fine fibers is not particularly limited, but a resin having the same component as the ultrafine fibers may be used, or a resin having a different component may be used. A combination of different types of resins is not particularly limited, and examples thereof include a non-elastomer resin/elastomer resin, a high melting point resin/low melting point resin, a high crystalline resin/low crystalline resin, a hydrophilic resin/water repellent resin, and the like. For example, it is possible to impart elasticity to the composite structure by combining ultrafine fibers formed of a non-elastomer resin and fine fibers formed of an elastomer resin, and when pleating is performed thereon for an air filter, it has an effect of curbing breakage due to bending.

The elastomer resin is not particularly limited, and examples thereof include a polyolefin-based elastomer, a polyester-based elastomer, a polyurethane-based elastomer, a polyamide-based elastomer, a fluorine-based elastomer, and the like. Further, it is possible to increase processing strength while maintaining the collection efficiency of the obtained composite structure by combining the ultrafine fibers formed of a high melting point resin and the fine fibers formed of a low melting point resin, performing heat treatment thereon at a temperature below the melting point of the ultrafine fibers and above the melting point of the fine fibers, and fusing the ultrafine fibers and the fine fibers or fusing the fine fibers. Furthermore, when integration with the base material or other layers is performed, since the fine fibers and the base material or other layers can be fused to each other, strength of an integrated stacked body can be further increased. The combination of the high melting point resin and the low melting point resin is not particularly limited, but a difference between the melting points is preferably 10° C. or more, and more preferably 20° C. or more. The combination of such resins is not particularly limited, and examples thereof include polyvinylidene fluoride/a copolymer of vinylidene fluoride and hexafluoropropylene, nylon 66/nylon 6, poly-L-lactic acid/a poly-D, L-lactic acid, polypropylene/polyethylene, polyethylene terephthalate/polyethylene, polyethylene terephthalate/polypropylene, and the like. Further, it is possible to impart dimensional stability to the composite structure by combining the ultrafine fibers formed of a high crystalline resin and the fine fibers formed of a low crystalline resin, and when it is used as a filter medium for a filter, the filter performance can be maintained even in a wide range of temperature and humidity environments. The high crystalline resin is not particularly limited, and examples thereof include polyvinylidene fluoride, nylon 6, nylon 66, polyethylene, polypropylene, polyethylene terephthalate, polylactic acid, polyvinyl alcohol, polyethylene glycol, and the like. The low crystalline resin is not particularly limited, and examples thereof include a copolymer of vinylidene fluoride and hexafluoropropylene, a copolymer of ethylene and propylene, poly-D, L-lactic acid, polystyrene, polysulfone, polyether sulfone, polycarbonate, polymethyl methacrylate, polyurethane, polyvinyl acetate, and the like.

The basis weight of the composite structure of the present invention is not particularly limited, but is preferably in a range of 0.1 to 20 g/m², more preferably in a range of 1 to 15 g/m², and even more preferably in a range of 3 to 10 g/m². When the basis weight is 0.1 g/m² or more, as a filter medium for a filter, it has a long lifespan, high collection efficiency, and it is possible to increase the processing strength of the filter, and when the basis weight is 20 g/m² or less, the pressure loss can be reduced as a filter medium for a filter.

An average flow rate pore diameter of the composite structure of the present invention is not particularly limited, but is preferably in a range of 1.0 to 10.0 μm, and more preferably in a range of 1.5 to 5.0 μm. When the average flow rate pore diameter is 1.0 μm or more, in the filter medium for a filter, it is less likely to be clogged with dust, and a filter having a long lifespan can be obtained. Further, when the average flow rate pore diameter is 10.0 μm or less, high collection efficiency can be obtained, and thus it is preferable.

The composite structure of the present invention is not particularly limited, but may be stacked and integrated with base materials such as other non-woven fabrics, woven fabrics, nets, and microporous films. It is possible to obtain a stacked body in which characteristics of the composite structure and the base materials are combined by stacking and integrating with the base material. When it is used as a filter medium for an air filter, the base material is preferably a non-woven fabric from the viewpoint of processability and air permeability. The composite structure integrated with the base material has not only filter characteristics derived from the composite structure such as high dust collection efficiency, high ventilation/liquid passage characteristics, and long lifespan characteristics which maintain the high ventilation/liquid passage characteristics even when dust is collected, but also exhibits extremely excellent water and oil repellent characteristics caused by the surface of the composite structure having a very fine uneven shape and also a high void structure. Examples of the characteristics of the base material to be combined with the composite structure include mechanical strength, wear resistance, a pleating property, an adhesive property, a filter property, and the like, and the base material having such characteristics can be appropriately selected according to the use and form of the composite structure. The method of stacking and integrating the composite structure and the base material is not particularly limited, and the separately manufactured composite structure and the base material may be integrated by an adhesive or heat fusion, or may be integrated by directly forming the composite structure on the base material, or the composite structure may be directly formed on the base material and then may be integrated by additional heat treatment.

When the base material is further stacked on the composite structure of the present invention, the basis weight of the base material is not particularly limited, and for example, a range of 5 to 200 g/m² can be exemplified. When the basis weight of the base material is 5 g/m² or more, it is possible to curb shrinkage, wrinkling, curling, and the like of the composite structure and to impart processing strength, and when it is 200 g/m² or less, the air filter can be made thinner, and productivity can be improved. When it is in a range of 60 to 120 g/m², it is more preferable because sufficient processing strength can be imparted and the thickness can be reduced. A specific volume of the base material is not particularly limited, but from the viewpoint of improving adhesion between the base material and the composite structure and reducing friction between the base material and the composite structure, it is preferably 5 cm³/g or less, and more preferably 3 cm³/g or less.

A material constituting the base material may be appropriately selected as needed and is not particularly limited. For example, when a polyolefin-based material such as polypropylene or polyethylene is used as the material, it is characterized by having excellent chemical resistance, and can be suitably used in applications such as liquid filters that require chemical resistance. When a polyester-based material such as polyethylene terephthalate, polybutylene terephthalate, polylactic acid, or a copolymer containing them as a main component is used as the material, for example, since it has excellent pleating characteristics, it can be suitably used in applications such as an air filter which requires the pleating. The polyester-based material has high wettability with an adhesive component such as hot melt, and can be suitably used when a product is processed by hot melt adhesion. A base material of which a surface is formed of a polypropylene-based or polyester-based material can be preferably used because it can be bonded by ultrasonic waves.

When the composite structure and the base material are integrated by heat treatment, it is not particularly limited, but it is preferable to use a non-woven fabric formed of a heat-fusible composite fiber configured of a low melting point component and a high melting point component as the base material. A combination of materials, a composite form, and a cross-sectional shape of the heat-fusible composite fiber are not particularly limited, and known ones can be used. Examples of the combination of materials include copolymerized polyethylene terephthalate and polyethylene terephthalate, copolymerized polyethylene terephthalate and polypropylene, high density polyethylene and polypropylene, high density polyethylene and polyethylene terephthalate, copolymerized polypropylene and polypropylene, copolymerized polypropylene and polyethylene terephthalate, polypropylene and polyethylene terephthalate, and the like. Further, when considering availability of the materials and the like, preferably, copolymerized polyethylene terephthalate and polyethylene terephthalate, high density polyethylene and polypropylene, high density polyethylene and polyethylene terephthalate, and the like can be exemplified. Further, as a composite form of a fiber cross section of the heat-fusible composite fiber, for example, a sheath core type, an eccentric sheath core type, a parallel type, or the like can be exemplified. The cross-sectional shape of the fiber is not particularly limited, and any cross-sectional shape such as an elliptical shape, a hollow shape, a triangular shape, a quadrangular shape, a double quatrefoil shape, or the like can be adopted in addition to a general round shape.

In the stacked body in which the composite structure and the base material are stacked, at least one layer selected from the group consisting of a non-woven fabric, a woven fabric, a net and a microporous film may be further stacked on at least one side or both sides thereof. Since a surface of the composite structure is not exposed on the surface by stacking at least one layer selected from the group consisting of a non-woven fabric, a woven fabric, a net, and a microporous film on the surface of the composite structure of the stacked body, the processability is further improved. Further, it is possible to further improve the filter lifespan by stacking at least one layer selected from the group consisting of a non-woven fabric, a woven fabric, a net, and a microporous film as a pre-collection layer on at least one surface of the stacked body. Although the manufacturing method for stacking at least one layer selected from the group consisting of a non-woven fabric, a woven fabric, a net and a microporous film on the stacked body is not particularly limited, a method in which the composite structure is directly formed on the base material to prepare a stacked body, and at least one layer selected from the group consisting of a non-woven fabric, a woven fabric, a net and a microporous film is further stacked and integrated on the stacked body in a post-process, and a method in which the composite structure is directly formed and integrated on a sheet in which at least one layer selected from the group consisting of a non-woven fabric, a woven fabric, a net and a microporous film and a base material are integrated are exemplified. The integrating methods are not particularly limited, and a thermocompression bonding treatment using a heated flat roll or an embossed roll, an adhesive treatment using a hot melt agent or a chemical adhesive, a heat bonding treatment using circulating hot air or radiant heat, or the like can be adopted.

The composite structure of the present invention may be subjected to electret processing, antistatic processing, water repellent processing, hydrophilic processing, antibacterial processing, ultraviolet absorption processing, near infrared absorption processing, antifouling processing, and the like according to the purpose, as long as the effects of the present invention are not significantly impaired.

The composite structure of the present invention is not particularly limited, but can be suitably used as a filter medium for a filter. When the composite structure of the present invention is used as a filter medium, the application thereof is not particularly limited, and it may be an air filter used for an air conditioner, a clean room, or the like, or a liquid filter used for filtering wastewater, paint, abrasive particles, or the like. A shape of the filter is not particularly limited, and may be a flat film type filter, a pleated filter, or a depth filter wound into a cylindrical shape. Since the composite structure of the present invention contains the ultrafine fibers and a large number of beads, it is possible to provide a filter medium having high dust collection efficiency, low pressure loss, and a long lifespan as a filter medium for a filter.

When the composite structure of the present invention and the stacked body are used as a filter medium for an air filter, the pressure loss when air is passed at a flow rate of 5.3 cm/sec is preferably in a range of 10 to 300 Pa, more preferably in a range of 20 to 200 Pa, and even more preferably in a range of 30 to 150 Pa. When the pressure loss is 10 Pa or more, sufficient collection efficiency can be obtained, and when the pressure loss is 300 Pa or less, effects in which power consumption when it is used as a filter medium of an air filter is reduced and a load on a fan is reduced are exhibited. Further, when air containing particles having a particle size of about 0.3 μm is passed at 5.3 cm/sec, the collection efficiency of the particles is preferably 90% or more, and more preferably 99% or more. Further, a PF value (=log(1−collection efficiency/100)/pressure loss×1000) is preferably 20 or more, and more preferably 25 or more. The PF value is a value used as an index indicating a magnitude of the collection performance of the filter medium for an air filter, and as performance thereof increases, the PF value increases. The lifespan of the air filter is not particularly limited, and can be evaluated by, for example, an adhesion weight of particles when air containing particles having a particle diameter of about 0.3 μm is continuously ventilated at a flow velocity of 5.3 cm/sec and the pressure loss increases by 250 Pa. As the adhesion weight increases, it can be used as the filter medium for an air filter having a long lifespan. The captured particles may be solid particles such as sodium chloride, or liquid particles such as a polyalphaolefin, and dioctylphthalate. The adhesion weight when the polyalphaolefin is used is not particularly limited, but is preferably 50 mg/100 cm² or more, and more preferably 100 mg/100 cm² or more. When the collection efficiency, the pressure loss, the PF value and the adhesion weight can be adjusted by appropriately changing the average fiber diameter of the ultrafine fibers, the average diameter or the content of the beads, and, when the fine fibers are contained, the average fiber diameter or ratio thereof, the basis weight of the composite structure, and the like.

The composite structure of the present invention is not particularly limited, but is preferably manufactured by an electrostatic spinning method. It is possible to produce very fine ultrafine fibers and beads at once using the electrostatic spinning method, and a composite structure exhibiting excellent filter characteristics can be obtained by a sensible process which does not require special equipment or special conditions. The electrostatic spinning method is a method in which a spinning solution is discharged and an electric field is applied to fiberize the discharged spinning solution, and submicron-order ultrafine fibers are collected on a collector in the form of a non-woven fabric. The electrostatic spinning method is not particularly limited, and examples thereof include a generally known method, for example, a needle method in which one or more needles are used, an air blow method in which productivity per needle is improved by injecting an airflow to a tip end of the needle, a porous spinneret method in which a plurality of solution discharge holes is provided in a single spinneret, a free surface method using a columnar or spiral wire-shaped rotating electrode semi-immersed in a solution tank, an electro-bubble method in which electrostatic spinning is performed with bubbles generated on a surface of a polymer solution by supplied air as a starting point, and the like, and it can be appropriately selected in consideration of the desired quality, productivity, or operability of the ultrafine fibers and the first beads. As the electrostatic spinning method of the composite structure in the present invention, the needle method, the air blow method, and the porous spinneret method in which a discharge amount per spinning jet can be controlled are particularly preferable in order to form the beads well.

The spinning solution is not particularly limited as long as it has spinnability, and a solution in which a resin is dispersed in a solvent, a solution in which a resin is dissolved in a solvent, a solution in which a resin is melted by heat or laser irradiation, or the like can be used. In order to obtain very fine and uniform fibers, it is preferable to use a resin dissolved in a solvent as a spinning solution.

Examples of the solvent in which a resin is dispersed or dissolved include water, methanol, ethanol, propanol, acetone, N,N-dimethylformamide, N,N-dimethylacetamide, dimethyl sulfoxide, N-methyl-2-pyrrolidone, toluene, xylene, pyridine, formic acid, acetic acid, tetrahydrofuran, dichloromethane, chloroform, 1,1,2,2-tetrachloroethane, 1,1,1,3,3,3-hexafluoroisopropanol, trifluoroacetic acid, and a mixture thereof. When they are mixed and used, a mixing ratio thereof is not particularly limited, and can be appropriately set in consideration of the desired spinnability, dispersibility, and physical properties of the obtained fiber.

A surfactant may be further contained in the spinning solution for the purpose of improving the stability and fiber forming property of the electrostatic spinning. Examples of the surfactant include anionic surfactants such as sodium dodecyl sulfate, cationic surfactants such as tetrabutylammonium bromide, and nonionic surfactants such as polyoxyethylene sorbitan monolaurate. A concentration of the surfactant is preferably in a range of 5% by weight or less with respect to the spinning solution. When it is 5% by weight or less, it is preferable because the effect suitable for use can be improved. In order to obtain the composite structure of the present invention, it is also preferable to prepare a spinning solution containing no surfactant and to perform the electrostatic spinning.

As long as the effects of the present invention are not significantly impaired, components other than the above such as a hydrophilic agent, a water repellent agent, a weather resistant agent, and a stabilizer may be included as components of the spinning solution. In particular, when the material of the composite structure contains a water and oil repellent component, adhesion energy of water droplets on the surface thereof becomes very low, and adhered dust can be easily washed with water or the like. The water and oil repellent agent is not particularly limited as long as it has an effect in which the adhesion energy is reduced, and examples thereof include a silicon-based silane compound, a fluorine-based silane compound, fluorooctylsilsesquioxane, a fluorine-modified polyurethane, and a silicon-modified polyurethane resin. A concentration of the water and oil repellent agent is preferably in a range of 0.1 to 20% by weight, more preferably in a range of 1 to 15% by weight with respect to a resin. When the concentration of the water oil repellent agent is 0.1% by weight or more, it is preferable because the water and oil repellent properties are improved, and when it is 20% by weight or less, it is preferable because the effect suitable for use can be improved.

A method of preparing the spinning solution is not particularly limited, and examples thereof include methods such as stirring and ultrasonic treatment. Further, the order of mixing is not particularly limited, and they may be mixed at the same time or sequentially. A stirring time when the spinning solution is prepared by stirring is not particularly limited as long as the resin is uniformly dissolved or dispersed in the solvent, and may be stirred for, for example, about 1 to 24 hours.

In order to obtain the composite structure containing the ultrafine fibers and the beads by the electrostatic spinning, a viscosity of the spinning solution is preferably adjusted in a range of 10 to 10,000 cP, more preferably in a range of 50 to 8,000 cP. When the viscosity is 10 cP or more, the spinnability and formability for forming the ultrafine fibers and the beads are obtained, and when the viscosity is 10,000 cP or less, the spinning solution can be easily prepared and discharged. The viscosity of the spinning solution can be adjusted by appropriately changing a molecular weight and concentration of the resin, a type of the solvent, and a mixing ratio thereof.

A temperature of the spinning solution is not particularly limited, and may be room temperature, or may be heated or cooled to be higher or lower than room temperature. Examples of a method of discharging the spinning solution include a method of discharging the spinning solution filled in a syringe from a nozzle using a pump, and the like. An inner diameter of the nozzle is not particularly limited, but is preferably in a range of 0.1 to 1.5 mm. A discharge amount is not particularly limited, but is preferably 0.1 to 10 mL/hr.

A method of applying an electric field to the spinning solution is not particularly limited as long as an electric field can be applied to the nozzle and the collector, and for example, a high voltage may be applied to the nozzle, and the collector may be grounded. The voltage to be applied is not particularly limited as long as the fibers are formed, but is preferably in a range of 5 to 100 kV. A distance between the nozzle and the collector is not particularly limited as long as ultrafine fibers and first beads are formed, but it is preferably in a range of 5 to 50 cm. The collector may be any one capable of collecting the spun composite structure, and a material and shape thereof are not particularly limited. As a material of the collector, a conductive material such as metal is preferably used. The shape of the collector is not particularly limited, and examples thereof include a flat plate shape, a drum shape, a shaft shape, a conveyor shape, and the like. When the collector has a flat plate shape or a drum shape, fiber aggregates can be collected in a sheet shape, and when the collector has a shaft shape, the fiber aggregates can be collected in a tube shape. When the collector has a conveyor shape, the fiber aggregates collected in the form of a sheet can be continuously produced.

### EXAMPLES

The Examples below are for illustration purposes only. The scope of the present invention is not limited to the present Examples.

A measurement method and a definition of physical property values shown in the Examples are shown below.

<Fiber Diameter of Ultrafine Fibers>

A composite structure was observed at a magnification of 10,000 to 30,000 using a scanning electron microscope (SU-8000) manufactured by Hitachi, Ltd., a diameter (a fiber diameter) of at least 500 fibers was measured using image analysis software, and an average value thereof was taken as an average fiber diameter. In addition, a coefficient of variation was calculated by dividing a standard deviation by the average value. Further, the number of fibers having a fiber diameter of 200 nm or less was divided by the total number of fibers and was then multiplied by 100 to calculate a proportion (%) of the fibers having the fiber diameter of 200 nm or less, and the number of fibers having a fiber diameter of 500 nm or more was divided by the total number of fibers and was then multiplied by 100 to calculate a proportion (%) of the fibers having the fiber diameter of 500 nm or less.

<Bead Diameter>

A surface of the composite structure was observed at an acceleration voltage of 3 kV at a magnification of 200 to 2,000 using a scanning electron microscope (SU-8000) manufactured by Hitachi, Ltd., and a diameter of at least 50 beads present on the outermost surface were measured using image analysis software, and an average value thereof was taken as an average diameter. Further, a bead content having a diameter of 5 μm or more was calculated by dividing the number of beads having a diameter of 5 μm or more by an image area. A diameter of the spindle-shaped beads is defined by a length of a minor axis thereof.

<Average Flow Rate Pore Diameter>

An average flow rate pore diameter was measured (JIS K 3822) using a Capillary Flow Composer (CFP-1200-A) manufactured by POROUS MATERIAL Co.

<Filter Performance>

Pressure loss and collection efficiency when polyalphaolefin (a particle size: 0.3 μm (a central diameter of the number thereof), and a particle concentration: 150 mg/m³) passed through a stacked body in which the composite structure was stacked on a base material at a measurement flow velocity of 5.3 cm/sec were measured using a filter efficiency automatic detection device (Model 8130) manufactured by TSI Co.

Further, an adhesion weight of particles when polyalphaolefin (a particle size: 0.3 μm (a central diameter of the number thereof), and a particle concentration: 150 mg/m³) is continuously ventilated at a measurement flow velocity of 5.3 cm/sec and the pressure loss increases by 250 Pa was measured using the filter efficiency automatic detection device (Model 8130) manufactured by TSI Co., and a lifespan of the filter was determined. As the adhesion weight of the particles until the pressure loss increases by 250 Pa becomes larger, the lifespan of the filter increases.

### Example 1

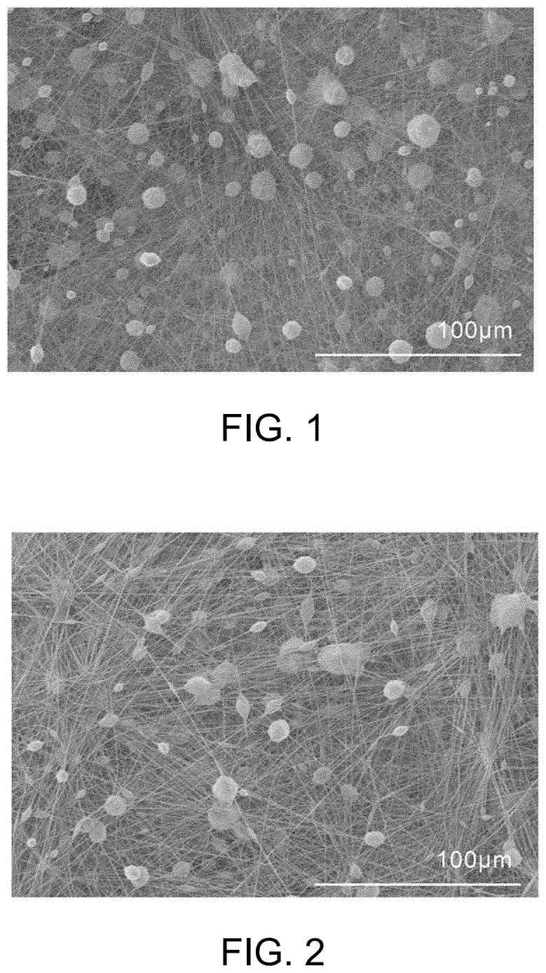

A spinning solution 1 configured of 16 parts by weight of polyvinylidene fluoride (Kynar761; a melting point was 165° C.) and 84 parts by weight of N,N-dimethylformamide manufactured by Arkema Co. was prepared. A non-woven fabric (a basis weight: 80 g/m²) formed of polyethylene terephthalate was attached to the collector surface as a base material using a drum-shaped rotation collector having a diameter of 200 mm as a collecting portion. Next, one needle having an inner diameter of 0.22 mm was mounted in a direction horizontal to a rotation direction of the rotation collector. The spinning solution 1 was supplied to a tip end of the needle at 2.0 mL/hr, and a voltage of 35 kV was applied to the needle to perform electrostatic spinning. A distance between the tip end of the needle and the grounded collector was 20 cm. A composite structure having a basis weight of 3.4 g/m² was stacked on the base material by the needle being traversed in a direction perpendicular to the rotation direction at a velocity of 100 mm/sec in a state in which a rotation velocity of the drum-shaped rotation collector is 50 rpm and the needle has a width of 200 mm, and the spinning being performed for 90 minutes. This stacked body was subjected to a filter performance test. As for the fibers in the composite structure, the average fiber diameter was 90 nm, the coefficient of variation of the fiber diameter was 0.47, the proportion of the ultrafine fibers of 200 nm or less was 98.3%, and the proportion of the fine fibers of 500 nm or more was 0%. The beads in the composite structure had an average diameter of 5.6 μm, and the number of beads having a diameter of 5 μm or more was 2709/mm². The average flow rate pore diameter of the obtained stacked body was 2.1 μm, and in the filter performance, the pressure loss was 69.7 Pa, the collection efficiency was 99.67%, a PF value was 35.5, and a dust retention amount was 57 mg/100 cm². A scanning electron microscope image of the obtained composite structure is shown in FIG. 1.

### Example 2

A spinning solution 2 configured of 16 parts by weight of polyvinylidene fluoride (Kynar761; a melting point was 165° C.), 67.2 parts by weight of N,N-dimethylformamide, and 16.8 parts by weight of acetone manufactured by Arkema Co. was prepared. A composite structure having a basis weight of 3.4 g/m² was stacked on the base material in the same manner as in Example 1 except that the spinning solution 2 was used. This stacked body was subjected to a filter performance test. As for the fibers in the composite structure, the average fiber diameter was 200 nm, the coefficient of variation of the fiber diameter was 0.41, the proportion of the ultrafine fibers of 200 nm or less was 51.1%, and the proportion of the fine fibers of 500 nm or more was 0%. The beads in the composite structure had an average diameter of 6.1 μm, and the number of beads having a diameter of 5 μm or more was 1696/mm². The average flow rate pore diameter of the obtained stacked body was 2.4 μm, and in the filter performance, the pressure loss was 74.7 Pa, the collection efficiency was 95.22%, the PF value was 17.7, and the dust retention amount was 121 mg/100 cm². A scanning electron microscope image of the obtained composite structure is shown in FIG. 2.

### Example 3

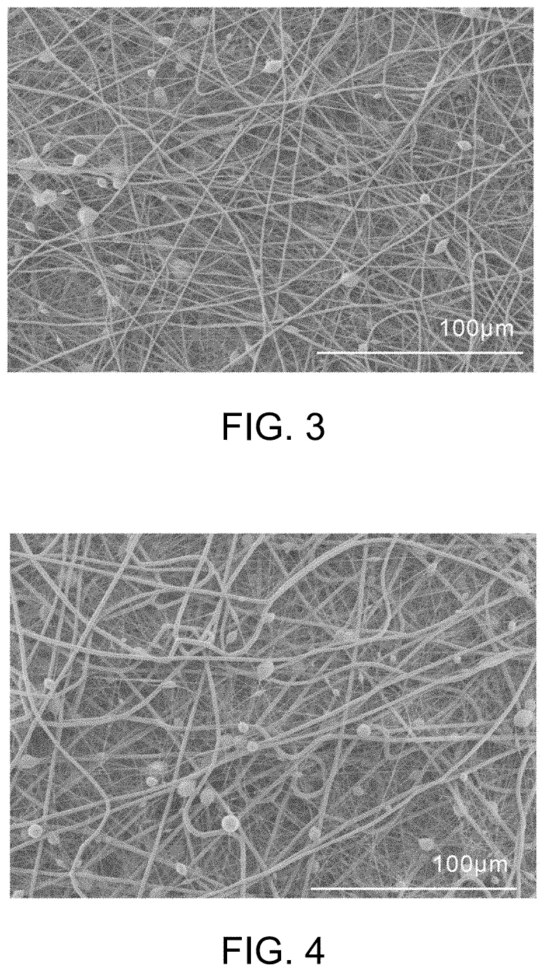

A spinning solution 3 for forming fine fibers which was configured of 25 parts by weight of polyvinylidene fluoride (Kynar 2500-20; a melting point was 125° C.), 37.5 parts by weight of N,N-dimethylformamide, and 37.5 parts by weight of tetrahydrofuran manufactured by Arkema Co. was prepared. A non-woven fabric (a basis weight: 80 g/m²) formed of polyethylene terephthalate was attached to the collector surface as a base material using a drum-shaped rotation collector having a diameter of 200 mm as a collecting part. Next, two needles having an inner diameter of 0.22 mm were mounted in a direction horizontal to the rotation direction of the rotation collector. The spinning solutions 1 and 3 were respectively supplied to tip ends of the needles at 2.0 mL/hr, and a voltage of 35 kV was applied to the needles to perform the electrostatic spinning. The distance between the tip ends of the needles and the grounded collector was 20 cm. A composite structure having a basis weight of 8.8 g/m² was stacked on the base material by the needle being traversed in a direction perpendicular to the rotation direction at a velocity of 100 mm/sec in a state in which a rotation velocity of the drum-shaped rotation collector is 50 rpm and the needle has a width of 200 mm, and spinning being performed for 90 minutes. This stacked body was subjected to a filter performance test. As for the fibers in the composite structure, the average fiber diameter was 250 nm, the coefficient of variation of the fiber diameter was 1.14, the proportion of the ultrafine fibers of 200 nm or less was 72.6%, and the proportion of the fine fibers of 500 nm or more was 16.7%. The beads in the composite structure had an average diameter of 5.6 μm, and the number of beads having a diameter of 5 μm or more was 2709/mm². The average flow rate pore diameter of the obtained stacked body was 1.8 μm, and in the filter performance, the pressure loss was 145.8 Pa, the collection efficiency was 99.96%, the PF value was 23.0, and the dust retention amount was 91 mg/100 cm². No fluffing occurred even when the surface of the stacked body on the side surface of the composite structure was rubbed, and the wear resistance and processability were very excellent. A scanning electron microscope image of the obtained composite structure is shown in FIG. 3.

### Example 4

A spinning solution 4 for forming the fine fibers which was configured of 30 parts by weight of polyvinylidene fluoride (Kynar 2500-20; a melting point was 125° C.), 17.5 parts by weight of N,N-dimethylformamide, and 52.5 parts by weight of tetrahydrofuran manufactured by Arkema Co. was prepared. Next, a composite structure having a basis weight of 9.9 g/m² was stacked on the base material in the same manner as in Example 3 except that the spinning solution 4 was used instead of the spinning solution 3. This stacked body was subjected to a filter performance test. As for the fibers in the composite structure, the average fiber diameter was 300 nm, the coefficient of variation of the fiber diameter was 1.89, the proportion of the ultrafine fibers of 200 nm or less was 85.7%, and the proportion of the fine fibers of 500 nm or more was 10.1%. The beads in the composite structure had an average diameter of 5.6 μm, and the number of beads having a diameter of 5 μm or more was 2709/mm². The average flow rate pore diameter of the obtained stacked body is 2.2 μm, and in the filter performance, the pressure loss was 114.3 Pa, the collection efficiency was 99.89%, the PF value was 25.8, and the dust retention amount was 113 mg/100 cm². No fluffing occurred even when the surface of the stacked body on the side surface of the composite structure was rubbed, and the wear resistance and processability were very excellent. A scanning electron microscope image of the obtained composite structure is shown in FIG. 4.

### Example 5

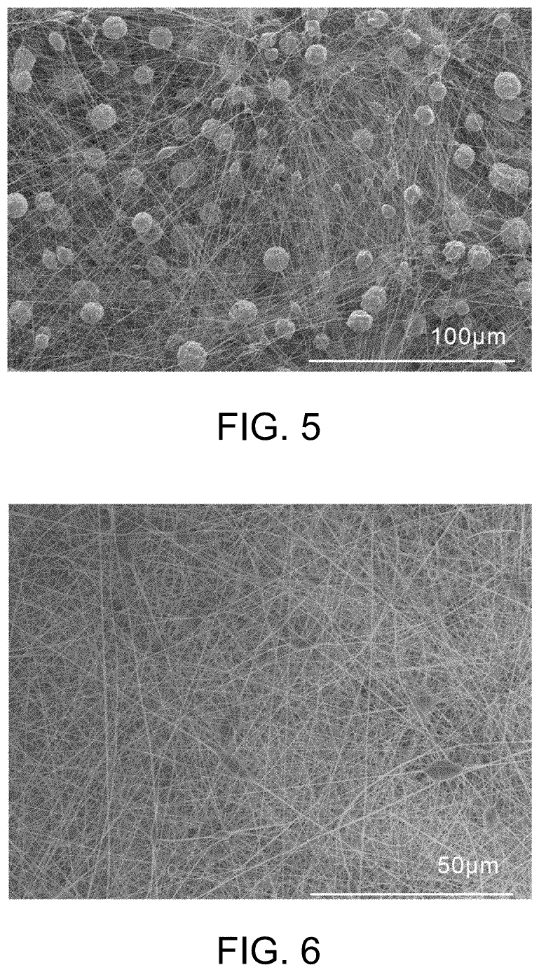

A spinning solution 5 configured of 20 parts by weight of polyvinylidene fluoride (Solf 6010; a melting point was 171° C.) and 80 parts by weight of N,N-dimethylformamide manufactured by Solvay Specialty Polymers Co. was prepared. A composite structure having a basis weight of 4.3 g/m² was stacked on the base material in the same manner as in Example 1 except that the spinning solution 5 was used. This stacked body was subjected to a filter performance test. As for the fibers in the composite structure, the average fiber diameter was 60 nm, the coefficient of variation of the fiber diameter was 0.45, the proportion of the ultrafine fibers of 200 nm or less was 97.3%, and the proportion of the fine fibers of 500 nm or more was 0%. The beads in the composite structure had an average diameter of 8.5 μm, and the number of beads having a diameter of 5 μm or more was 1773/mm². The average flow rate pore diameter of the obtained stacked body is 3.6 μm, and in the filter performance, the pressure loss was 44.0 Pa, the collection efficiency was 99.85%, the PF value was 64.2, and the dust retention amount was 150 mg/100 cm². A scanning electron microscope image of the obtained composite structure is shown in FIG. 5.

### Comparative Example 1

A spinning solution 6 configured of 16 parts by weight of polyvinylidene fluoride (Kynar761; melting point 165° C.), 84 parts by weight of N,N-dimethylformamide, and 0.05 parts by weight of sodium dodecyl sulfate manufactured by Arkema Co. was prepared. Next, a fiber layer having a basis weight of 1.5 g/m² was stacked on the base material using the spinning solution 6 in the same manner as in Example 1 except that the distance between the tip end of the needle and the grounded collector was 15 cm and the spinning time was 39 minutes. This stacked body was subjected to a filter performance test. As for the fibers in the fiber layer, the average fiber diameter was 90 nm, the coefficient of variation of the fiber diameter was 0.49, the proportion of the fibers having a fiber diameter of 200 nm or less was 86.2%, and the proportion of the fibers having a fiber diameter of 500 nm or more was 0.7%. The beads in the fiber layer had an average diameter of 2.5 μm, and the number of beads having an average diameter of 5 μm or more was 397/mm². The average flow rate pore diameter of the obtained stacked body was 0.9 μm, and in the filter performance, the pressure loss was 126.3 Pa, the collection efficiency was 99.55%, the PF value was 18.6, the dust retention amount was 16 mg/100 cm², the PF value was low, and the lifespan was short. A scanning electron microscope image of the obtained fiber layer is shown in FIG. 6.

### Comparative Example 2

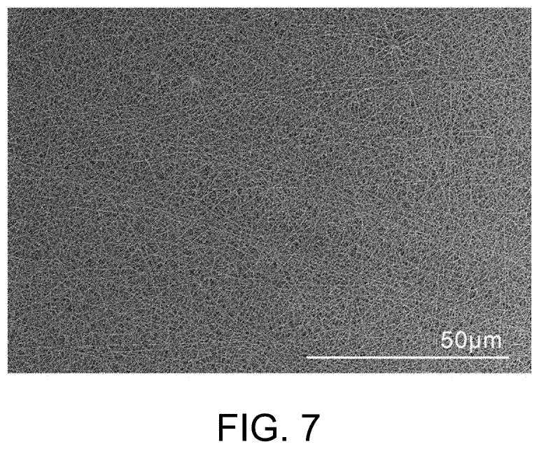

A spinning solution 7 configured of 15 parts by weight of polyamide 6 (1011 FB; a melting point was 220° C.), 42.5 parts by weight of formic acid, and 42.5 parts by weight of acetic acid manufactured by Ube Industries Co. was prepared. Next, a fiber layer having a basis weight of 0.2 g/m² was stacked on the base material using the spinning solution 7 in the same as in Example 1 except that a solution supply amount was 0.5 mL/hr, the distance between the tip end of the needle and the grounded collector was 7.5 cm, and the spinning time was 24 minutes. This stacked body was subjected to a filter performance test. As for the fibers in the fiber layer, the average fiber diameter was 70 nm, the coefficient of variation of the fiber diameter was 0.25, the proportion of the fibers having a fiber diameter of 200 nm or less was 100%, the ratio of the fibers having a fiber diameter of 500 nm or more was 0%, and no beads were present. The average flow rate pore diameter of the obtained stacked body is 0.6 μm, and in the filter performance, the pressure loss was 125.0 Pa, the collection efficiency was 99.81%, the PF value was 21.8, the dust retention amount was 5 mg/100 cm2, and the PF value was a little high, but the lifespan was very short. A scanning electron microscope image of the obtained fiber layer is shown in FIG. 7.

For the composite structures of Examples 1 to 5 and the fiber layers of Comparative Examples 1 and 2, Table 1 shows the average fiber diameter, the proportion of fibers of 200 nm or less, the proportion of fibers of 500 nm or more, the average diameter of beads, the number of beads of 5 μm or more, the basis weight, the pressure loss, the collection efficiency, the PF value, and the filter lifespan.

TABLE 1

| | | | | | Beads | | | | | | | |
|---|---|---|---|---|---|---|---|---|---|---|---|---|
| | | | | | | Number | | | | | | |
| | Fiber | | | | | of | | | Average | | | |
| | | | Proportion | Proportion | | beads of | | | flow | | | Dust |
| | Average | | of fibers | of fibers | | 5 μm | | | rate | | | retention |
| | fiber | Coefficient | of 200 nm | of 500 nm | Average | or more | Basis | Pressure | pore | Collection | PF | amount |
| | diameter | of | or less | or less | diameter | number/ | weight | loss | diameter | efficiency | value | Mg/ |
| | nm | variation | % | % | μm | mm² | g/m² | Pa | μm | % | 1/Pa | 100 cm² |
| Example 1 | 90 | 0.47 | 98.3 | 0 | 5.6 | 2709 | 3.4 | 69.7 | 2.1 | 99.67 | 35.5 | 57 |
| Example 2 | 200 | 0.41 | 51.1 | 0 | 6.1 | 1695 | 3.4 | 74.7 | 2.4 | 95.22 | 17.7 | 121 |
| Example 3 | 250 | 1.14 | 72.6 | 16.7 | 5.6 | 2709 | 8.8 | 145.8 | 1.8 | 99.96 | 23.0 | 91 |
| Example 4 | 300 | 1.89 | 85.7 | 10.1 | 5.6 | 2709 | 9.9 | 114.3 | 2.2 | 99.89 | 25.8 | 113 |
| Example 5 | 60 | 0.45 | 97.3 | 0 | 8.5 | 1773 | 4.3 | 44.0 | 3.6 | 99.85 | 64.2 | 150 |
| Comparative | 90 | 0.49 | 86.2 | 0.7 | 2.5 | 397 | 1.5 | 126.3 | 0.9 | 99.55 | 18.6 | 16 |
| Example 1 | | | | | | | | | | | | |
| Comparative | 70 | 0.25 | 100 | 0 | — | 0 | 0.2 | 125.0 | 0.6 | 99.81 | 21.8 | 5 |
| Example 2 | | | | | | | | | | | | |

As is clear from Table 1, in Examples 1 to 5 containing beads of 500/mm² having a diameter of 5 μm or more, the PF value is large, the dust retention amount is large, and the filter lifespan is long, compared with Comparative Examples 1 and 2 not containing beads of at least 500/mm² having a diameter of 5 μm or more. Further, in Examples 3 and 4 which include the fine fibers having a fiber diameter of 500 nm or more in addition to the ultrafine fibers having a fiber diameter of 200 nm or less, no fluffing occur even when the surface of the composite structure was rubbed, and the processability to a filter such as pleating was excellent.

### INDUSTRIAL APPLICABILITY

Since the composite structure of the present invention and the filter medium using the same have high dust collection efficiency, low pressure loss, long lifespan, or have an excellent balance of these effects and are excellent in processing strength to a filter, they can be suitably used as a filter medium for an air filter or a filter medium for a liquid filter. In particular, it will be possible to provide filter media suitable for air filters for home appliances such as vacuum cleaners and air purifiers, air filters for building air conditioning, medium and high-performance industrial filters, HEPA filters for clean rooms, and ULPA filters.

1. A composite structure containing ultrafine fibers having a fiber diameter of less than 500 nm and beads, wherein the beads of at least 500/mm² having a diameter of 5 μm or more are contained on an outermost surface of the composite structure,
wherein the ultrafine fibers and the beads have the same component.

2. (canceled)

3. The composite structure according to claim 1, wherein 50% or more of ultrafine fibers having a fiber diameter of 200 nm or less is contained with respect to the total fibers.

4. The composite structure according to claim 1, wherein 5% or more of ultrafine fibers having a fiber diameter of 500 nm or less is further contained with respect to the total fibers.

5. A filter medium including the composite structure according to claim 1.

6. A method of manufacturing the composite structure according to claim 1, the method comprising:
preparing a spinning solution in which at least one resin selected from a group consisting of polyvinylidene fluoride, polyamide, polyurethane, and polylactic acid is dissolved in a solvent; and
spinning the spinning solution in an electrostatic spinning method and obtaining a composite structure containing ultrafine fibers having a fiber diameter of less than 500 nm and beads.

7. The composite structure according to claim 3, wherein 5% or more of ultrafine fibers having a fiber diameter of 500 nm or less is further contained with respect to the total fibers.

8. A filter medium including the composite structure according to claim 3.

9. A filter medium including the composite structure according to claim 4.

10. A filter medium including the composite structure according to claim 7.

11. A method of manufacturing the composite structure according to claim 3, the method comprising:
preparing a spinning solution in which at least one resin selected from a group consisting of polyvinylidene fluoride, polyamide, polyurethane, and polylactic acid is dissolved in a solvent; and
spinning the spinning solution in an electrostatic spinning method and obtaining a composite structure containing ultrafine fibers having a fiber diameter of less than 500 nm and beads.

12. A method of manufacturing the composite structure according to claim 4, the method comprising:
preparing a spinning solution in which at least one resin selected from a group consisting of polyvinylidene fluoride, polyamide, polyurethane, and polylactic acid is dissolved in a solvent; and
spinning the spinning solution in an electrostatic spinning method and obtaining a composite structure containing ultrafine fibers having a fiber diameter of less than 500 nm and beads.

13. A method of manufacturing the composite structure according to claim 7, the method comprising:
preparing a spinning solution in which at least one resin selected from a group consisting of polyvinylidene fluoride, polyamide, polyurethane, and polylactic acid is dissolved in a solvent; and
spinning the spinning solution in an electrostatic spinning method and obtaining a composite structure containing ultrafine fibers having a fiber diameter of less than 500 nm and beads.
